(19) United States
(12) Patent Application Publication
(10) Pub. No.: US 2025/0290576 A1
(43) Pub. Date: Sep. 18, 2025

(54) A METHOD OF LAYING A SUBSEA PIPE

(71) Applicant: TECHNIPFMC SUBSEA FRANCE, Courbevoie (FR)

(72) Inventors: Mahir ABDUALLAYEV, Aberdeen, Aberdeenshire (GB); Julien CAINE, Stonehaven, Aberdeenshire (GB)

(21) Appl. No.: 18/860,168

(22) PCT Filed: Apr. 25, 2023
(86) PCT No.: PCT/IB2023/000232

§ 371 Date: Oct. 25, 2024

(30) Foreign Application Priority Data
Apr. 26, 2022 (GB) 2206077.6
Aug. 26, 2022 (GB) 2212438.2

(51) Int. Cl. F16L 1/235; F16L 1/19

(52) U.S. Cl. CPC F16L 1/235; F16L 1/19

(57) ABSTRACT

The invention relates to a method for laying a subsea pipe. In particular, the invention relates to a method for laying a subsea pipe by means of a pipe reel laying vessel. The method is for laying a pipe (3) in a subsea location, the method comprising:
a) configuring a straightener system (25) to straighten a pipe, and unwinding the pipe (3) from the reel to provide a straight portion (19) of pipe having a predetermined length (LS) greater than 300 m;
b) configuring the straightener system (25) to provide a non-straight portion of pipe (24) having a predetermined length (LE);

wherein the non-straight portion of pipe (24) produced during step b) comprises at least one under-straightened sub-portion of pipe (21) and at least one over-straightened sub-portion of pipe (22, 23).

### TECHNICAL FIELD

The invention relates to a method for laying a subsea pipe. In particular, the invention relates to a method for laying a subsea pipe by means of a pipe reel laying vessel.

### BACKGROUND

Pipelines are used in the offshore hydrocarbon production industry to transfer oil and gas from a well towards a storage and/or processing facility. Such pipelines are typically installed on the seabed using reel lay installation vessels, and often span huge distances.

During transfer of hydrocarbon well fluids along a pipeline, the fluids inside the pipeline can reach high temperatures, e.g. greater than about 80° C. and even up to about 165° C. Transfer of such high temperature fluids can cause thermal gradients across the pipeline, especially during multiple production shut down and start up cycles. Repeated expansion, contraction and thermal cycling of the pipeline can lead to pipeline buckling, movement and loading that create both static peak and cyclic stresses. Overstrain and fatigue failures can occur along the length of the pipeline at locations that are relatively vulnerable and prone to these types of failure.

In the past, the risk of pipeline failure has been mitigated by allowing controlled lateral buckling at locations along the pipeline which are determined analytically, such as by finite element analysis. Such mitigation measures reduce the lateral resistance of the pipeline so that the pipeline can deform or “buckle” in a smooth and controlled manner. In other words, the use of the mitigation measures facilitates the formation of an arc along the length of the pipeline in response to the stresses in the pipeline created by thermal gradients. This results in the development of smoother and more benign deformation, and therefore less strain and fatigue on the pipeline, than would occur without the use of the mitigation measures.

EP1358420 discloses a mitigation measure, which is applicable to pipeline installed by reel-lay and which is called ‘Residual Curvature Method’ (RCM). The RCM exploits the conventional straightener system of a reel-lay installation vessel. Aboard the vessel a pipe is spooled and transported in a plastically deformed state, typically with 2% bending strain. The pipe passes through the straightener system, which generally comprises rollers, after being unspooled from a reel of the vessel. This reverses the plastic deformation that was imparted to the pipe upon spooling.

In accordance with the RCM, the radius of curvature of the pipe is modified locally by periodically changing the straightening force that is applied to the pipeline. Typically the pipe is under-straightened locally at longitudinal intervals as the pipe is launched into the sea. This forms a series of laterally-extending thermal expansion loops of locally-increased curvature-that is, with a locally-reduced radius of curvature-that are distributed longitudinally along the pipe between straighter portions of lesser curvature, preferably with substantially uniform spacing between them. A thermal expansion loop made with the RCM is also called ‘Residual Curvature section’ or ‘RC section’.

A “non-straight” portion of pipe having a length preferably comprised between 30 m and 250 m is known from the RCM (Residual Curvature Method) prior art and it is generally called a “Residual Curvature section” or “RC section” or “RC feature” by the skilled man. Before being launched into the sea, the RC section is comprised or almost comprised in a plane which is the same or almost the same plane as the one of the bending supports of the straightener system, preferably a vertical plane when the reel axis is horizontal.

A reel-lay vessel 1 according to the prior art is shown in FIGS. 1 and 2. The vessel 1 comprises a reel 4 wound with a plastically deformable rigid pipe 3. The plastically deformable rigid pipe 3 has an initial curvature when wound on the reel 4. The initial curvature depends on the radius of the reel 4. The pipe 3 is gradually unwound from the reel 4 during subsea installation of the pipe 3. The vessel 1 comprises a straightener system 25 through which the pipe 3 is fed before being installed on the sea bed 16. The vessel 1 comprises a tensioning arrangement 10, such as caterpillars, through which the pipe 3 is fed before being installed on the sea bed 16. The tensioning arrangement 10 is located downstream of the straightener system 25.

The tensioning arrangement 10 is used to withstand the tension applied by the pipe 3 to the vessel 1 during subsea installation of the pipe 3. The tension applied by the pipe 3 to the vessel 1 is mainly due to the weight of the pipe 3.

The straightener system 25 comprises bending supports 7, 8, 9 such as rollers or tracks. The bending supports 7, 8, 9 are for applying a curvature, such as a reverse curvature, to the pipe 3. By “reverse curvature” it is meant a curvature which is opposite the initial curvature of the pipe 3. The bending supports 7, 8, 9 are adjustable i.e. they have one or more adjustable settings. The one or more adjustable settings include relative spacing or positioning of the bending supports 7, 8, 9. The one or more adjustable settings allow the amount of pressure applied by the bending supports to the pipe 3 to be adjusted. The bending supports 7, 8, 9 are coplanar or almost coplanar and arranged in a vertical plane perpendicular or almost perpendicular to the axis of the reel 4.

The straightener system 25 is adapted to perfectly straighten or almost perfectly straighten the pipe 3 such that the pipe is straight or substantially straight with no residual curvature. This allows the installation of substantially straight portions of pipe 17, 19. The straightener system 25 is also configured to periodically under-straighten the pipe 3 such that the pipe 3 has a constant or substantially constant pre-determined residual curvature in the same direction as the initial curvature. This allows the formation of short length RC sections at pre-determined positions along the pipe 3. The residual curvature of each RC section 20 is in the same direction as the initial curvature.

### PROBLEMS TO BE SOLVED

For effective implementation, the RC section 20 should be installed horizontally on the sea bed 16, because the horizontal plane is the plane of lateral buckling when the pipe 3 is in service. The RC feature however is imposed at the reel-lay vessel in the vertical plane. When launched into the sea the RC section 20 faces upward in a vertical plane, as shown in FIG. 2.

When launched into the sea, the RC section 20 has a residual curvature which is in the opposite direction to the curvature of the sag bend 18 at the bottom of the catenary close to the sea bed 16. As a consequence of these curvatures having opposite directions, the pipe 3 tends to rotate when the RC section 20 enters the sag bend 18. This rotation can be predicted theoretically through calculation of the minimum total bending energy in the catenary.

The final orientation of the RC feature on the seabed depends on several factors, including: pipeline diameter and torsional stiffness; RC feature configuration (length, offset, curvature); tension and torsion in the catenary (including external environmental loads); water depth and stiffness of the catenary (including boundary conditions, seabed contact); and pipe/seabed interaction which can push the RC feature to rotate on touchdown.

As shown in FIG. 3, the rotation of the pipe 3 is measured with reference to an upward vertical direction corresponding to the initial angular position of the RC section 20 when it enters the sea surface 2. A rotation of 0° corresponds to a RC section 20 which is laid vertically on the sea bed 16 and which faces upward. A rotation of 90° corresponds to a RC section 20 which is laid horizontally on the sea bed 16. A rotation of 180° corresponds to a RC section 20 which is laid vertically on the sea bed 16 and which faces downward.

It is important that the RC section 20 is laid horizontally on the sea bed 16, i.e. with a rotation of around 90°, otherwise the RC section 20 will not efficiently initiate controlled and safe buckles when the pipe 3 is in service and withstands large axial compressions due to thermal expansion.

Experience has shown that this prior art method described above has a too limited range in terms of water depth. It does not work properly in deep water because the RC section 20 rotates too much (between 135° and 180°). This results in the RC section 20 being partially embedded in the soil and locked to the seabed, which is detrimental for the controlled lateral buckling of the pipe.

For effective implementation of the RCM, each RC section should be installed in the plane of the seabed, i.e. installed horizontally on the seabed, because the seabed plane is the plane of lateral buckling during operation of the pipe. The advantage of installing a RC section horizontally is that lateral buckling will be more easily initiated when the pipe is in service, hence ensuring a smooth and controlled lateral buckling without any risk of damaging the pipe.

Each RC section however is imposed/made by the straightener system of the reel-lay vessel, which is far away from the seabed. Furthermore the straightener system generally acts in a vertical plane because of the reel having a horizontal axis. Therefore, each RC section is oriented in a vertical plane before being launched into the sea. As a consequence, it is necessary to rotate each RC section by 90° during its descent from the surface to the seabed so that it lands horizontally on the seabed. The pipe tends to rotate when a RC section enters the sag bend close to the sea bed. This rotation can be predicted theoretically through calculation of the minimum total bending energy in the catenary.

Experience has shown that this natural rotation can be closed to 90° in some applications, typically shallow water applications, which then provides a simple and efficient way to install a RC section in the plane of the seabed.

However, experience has also shown that there exist applications, typically deep water applications, wherein the RC sections may land on the seabed with different orientations, including facing downwards into the seabed (rotation of around 180°). Such an orientation is detrimental because such a RC section is partially embedded in the soil, locked to the seabed and cannot thus efficiently initiate a controlled lateral buckling of the pipe.

The present invention aims at solving the problem of orientation of the RC sections (thermal expansion loops made with the RCM) and provide a simple and efficient way to ensure that the RC sections are installed in the plane of the seabed, which improves the buckling initiation and thermal expansion control once the pipe is in service.

This invention relates to the challenges of mitigating or controlling buckling during the installation and operation of subsea pipes, particularly those for carrying fluids such as hydrocarbons, of the rigid single or double-wall (“pipe-in-pipe”) type, with or without thermal insulation. More precisely the invention relates to providing sections of reeled pipe with higher residual curvature as installed as a result of a modified straightening process.

### OBJECTS OF THE INVENTION

It is an object of the invention to provide a method for laying a subsea pipe.

It is a further object of the invention to mitigate against pipeline failure.

It is a further object of the invention to provide a modified straightening procedure for a plastically deformed rigid pipe.

It is a further object of the invention to provide a method for laying an RC section in a predetermined orientation, such as horizontal on the sea bed.

It is a further object of the invention to control the RC feature rotation in the sag bend.

It is a further object of the invention to increase the probability of the RC landing on the seabed in the horizontal plane while still fulfilling its global buckling mitigation purpose.

### SHORT SUMMARY OF THE INVENTION

According to a first aspect of the invention there is provided a method for laying a pipe on a seabed from a vessel, said vessel comprising a reel wound with deformable rigid pipe having an initial curvature and a straightener system through which the pipe is provided the method comprising at least the following steps:
a) configuring the straightener system to straighten a pipe, and unwinding the pipe from the reel to provide a straight portion of pipe having a predetermined length (LS) greater than 300 m (300 meters);
b) configuring the straightener system to provide a non-straight portion of pipe having a predetermined length (LE);
wherein the non-straight portion of pipe produced during step b) comprises at least one under-straightened sub-portion of pipe and at least one over-straightened sub-portion of pipe.

Optionally, the straightener system comprises bending supports for applying a curvature to the pipe.

Optionally, the straightener system comprises bending supports for applying a reverse curvature to a pipe, and having one or more adjustable settings selected from relative spacing or positioning of the bending supports and/or amount of pressure applied by the bending supports to the pipe, said straightener system (25) being adapted to straighten the pipe and leave the pipe with no residual curvature, and/or to under-straighten the pipe and leave the pipe with a residual curvature in the same direction as the initial curvature, and/or to over-straighten the pipe and leave the pipe with a residual curvature in the opposite direction as the initial curvature.

Optionally, step (b) comprises configuring the straightener system to two or more of the group comprising: to under-straighten a sub-portion of the pipe, to over-straighten a sub-portion of the pipe, and to straighten a sub-portion of the pipe; followed after each configuration by unwinding the sub-portion of the pipe from the reel.

In this way, step (b) comprises two or more adjustments of the straightener system to provide the non-straight portion of pipe. Such adjustments may also be termed providing an under-straightening configuration, an over-straightening configuration, and a straightening configuration. After each such adjustment to a different configuration, the relevant sub-portion of the pipe is unwound from the reel.

In this way, the length of each sub-portion can be accurately determined or measured, especially to ensure consistency with a pre-planned or predesigned overall configuration of laying the overall pipe.

After each set of configuration adjustments in step (b), the straightener system can be returned to the straight pipe configuration to step (a), before any further non-straight portion of the pipe is required. In this way, the method of the present invention can lay a pipe from a vessel having a varying number of straight and non-straight portions along the length of the pipe during laying. The user is not limited to the number of straightener system configurations, the order of such configuration changes, the timing of configuration changes, etc. to achieve different lengths or amounts of over-straightening or under-straightening for each sub-portion of the pipe.

Optionally, the non-straight portion of pipe consists of or comprises only one under-straightened sub-portion of pipe and at least one over-straightened sub-portion of pipe. This arrangement can be achieved by step (b) of the method comprising only one under-straightening configuration in forming the non-straight portion of the pipe.

Optionally, the non-straight portion of pipe consists of or comprises at least one under-straightened sub-portion of pipe and only one over-straightened sub-portion of pipe. This arrangement can be achieved by step (b) of the method comprising only one over-straightening configuration in forming the non-straight portion of the pipe.

Optionally, the non-straight portion of pipe consists of or comprises only two over-straightened sub-portions of pipe which are located on each side of the under-straightened sub-portion of pipe. This arrangement can be achieved by step (b) of the method comprising only one under-straightening configuration in forming the non-straight portion of the pipe.

Optionally, the non-straight portion of pipe consists of or comprises only one over-straightened sub-portion of pipe and only two under-straightened sub-portions of pipe which are located on each side on the over-straightened sub-portion of pipe. This arrangement can be achieved by step (b) of the method comprising an under-straightening configuration, an over-straightening configuration, and an under-straightening configuration in forming the non-straight portion of the pipe, prior to return to step (a).

Optionally, the non-straight portion of pipe consists of or comprises only two under-straightened sub-portions of pipe and only two over-straightened sub-portions of pipe. This arrangement can be achieved by step (b) of the method comprising an under-straightening configuration, an over-straightening configuration, an under-straightening configuration, and an over-straightening configuration in forming the non-straight portion of the pipe, prior to return to step (a).

Optionally, the non-straight portion of pipe comprises at least one straight sub-portion of pipe located between at least one under-straightened sub-portion of pipe and at least one over-straightened sub-portion of pipe. This arrangement can be achieved by step (b) of the method comprising a straightening configuration in forming the non-straight portion of the pipe.

Optionally, the non-straight portion of pipe is arranged in a symmetric or anti-symmetric or asymmetric way with reference to the center of the non-straight portion of pipe. This arrangement can be achieved by step (b) of the method comprising one or more different arrangements of the configurations in forming the non-straight portion of the pipe. The differences may be in terms of the amount or length of pattern, or a combination of two or more of same, of the configurations used in step (b).

Optionally, the local residual strain of the or each under-straightened sub-portion of pipe is between 0.08% and 0.25%.

Optionally, the local residual strain of the or each over-straightened sub-portion of pipe is between 0.02% and 0.1%.

Optionally, the or each under-straightened sub-portion of pipe has a length between 15 m and 125 m.

Optionally, the or each over-straightened sub-portion of pipe has a length between 15 m and 125 m.

Optionally, the or each straight sub-portion of pipe within a non-straight portion of the pipe has a length between 15 m and 70 m.

Optionally, the method comprises adjusting the settings of the straightener system to provide a different configuration of the straightener system in step (a) or step (b), and wherein the vessel is stationary when the settings of the straightener system (25) are adjusted.

Optionally, the method comprises adjusting the settings of the straightener system to provide a different configuration of the straightener system in step (a) or step (b), and wherein the reel is stopped or stationary when the settings of the straightener system are adjusted. As such, there is no axial relative movement between the pipe and the straightener system.

That is, the method optionally further comprises the step of stopping the reel prior to adjusting the settings of the straightener system to provide a different configuration of the straightener system in step (a) or step (b). Once the settings of the straightener system have been adjusted to provide a different configuration of the straightener system in step (a) or step (b), the reel is started again to continuing the laying of the pipeline from the vessel.

Thus, in one embodiment of the present invention, there is provided a method for laying a pipe on a seabed from a vessel, said vessel comprising a reel wound with deformable rigid pipe having an initial curvature and a straightener system through which the pipe is provided the method comprising at least the following steps:
a) configuring the straightener system to straighten a pipe, and unwinding the pipe from the reel to provide a straight portion of pipe having a predetermined length (LS) greater than 300 m (300 meters);
b) configuring the straightener system to provide a non-straight portion of pipe having a predetermined length (LE);
wherein the non-straight portion of pipe produced during step b) comprises at least one under-straightened sub-portion of pipe and at least one over-straightened sub-portion of pipe; and
laying a length of the pipe;
stopping the reel to allow for adjusting the settings of the straightener system to provide a different configuration of the straightener system; and
restarting the reel to continue the laying of the pipe on the seabed from the vessel.

The skilled person can see that the present invention provides a method able to achieve different variations in different portions of the pipe along its length as the pipe is being laid from the reel.

The present invention also extends to the method optionally further comprising the step of slowing the reel prior to adjusting the settings of the straightener system to provide a different configuration of the straightener system in step (a) or step (b), wherein the step of adjusting the settings of the straightener system to provide a different configuration of the straightener system in step (a) or step (b) is carried out while the reel is rotating and while the pipe is moving axially through the straightener system, and wherein the amplitude of the axial movement of the pipe through the straightener system remains low, typically less or equal than 6 meters, optionally between 1 meter and 6 meters, while the settings of the straightener system are changed or adjusted. According to this embodiment, the reel is not stopped and goes on rotating, preferably at reduced speed, while the settings of the straightener system are changed, which creates along the pipe a transition area which has a variable residual curvature, said transition area being located in between two adjacent portions or sub-portions of pipe which have both substantially constant residual curvatures. The length of this transition area is equal to the amplitude of the axial movement of the pipe through the straightener system while the settings of the straightener system are changed or adjusted. In other words, the length of a transition area is the length of pipe which passes through the straightener system while the settings of the straighter system are changed or adjusted. The length of the transition area is preferably less or equal than 6 meters and more preferably comprised between 1 and 6 meters. The length of the transition area is preferably at least 30 times smaller than the predetermined length (LE) of the non-straight portion of pipe wherein the transition area is located. This can be achieved by slowing down the reel rotation during the adjustment of the straightener settings and/or by reducing the time required to change the settings, for example by using more powerful and faster actuators to change the relative position of the bending supports. A controller unit can be used to measure the pipe payout (i.e. spooling off) speed and position, and provide the required adjustments to the straightener system to still suit the expected modelling or design parameters.

Both methods wherein the reel is stopped and wherein the reel is slowed down can be combined for laying a pipe according to the present invention. For example, a few transitions between portions or sub-portions of pipes having different residual curvatures are done by stopping the reel while the settings of the straightener system are adjusted, and a few other transitions are done by slowing down the reel while the settings of the straightener system are adjusted. All possible combinations can be used without departing from the present invention. All transitions can be done by stopping the reel, or all transitions can be done by slowing down the reel, or some of the transitions can be done by stopping the reel and the remaining ones by slowing down the reel.

The adjustments are preferably to the settings discussed herein relating to the relative spacing or positioning of the bending supports and/or amount of pressure applied by the bending supports to the pipe.

Optionally, the method comprises repeating steps a) and b) until the deformable rigid pipe is fully installed on a seabed.

Optionally, the method comprises the further step of;
b0) Designing the characteristics of the non-straight portion of pipe to control the rotation of the non-straight portion of pipe in the catenary free span between the vessel and the sea bed and ensure that the non-straight portion of pipe is installed horizontally on the seabed.

Optionally, the non-straight portion of pipe has a predetermined length (LE) between 30 m and 250 m.

Optionally, the predetermined length (LS) of the straight portion of pipe is greater than 500 meters, preferably greater than 700 meters.

According to a further aspect of the present invention there is provided a method for laying a pipe on a seabed with a vessel in order to provide controlled thermal expansion, said vessel comprising a reel wound with plastically deformed rigid pipe having an initial curvature and a straightener system through which the pipe is fed before being installed subsea, said straightener system comprising bending supports for applying a reverse curvature to the pipe and having one or more adjustable settings selected from relative spacing or positioning of the bending supports and/or amount of pressure applied by the bending supports to the pipe, said straightener system being able depending on the settings which are selected to straighten the pipe and leave it with no residual curvature, or to under-straighten the pipe and leave it with a residual curvature in the same direction as the initial curvature, or to over-straighten the pipe and leave it with a residual curvature in the opposite direction as the initial curvature, said method comprising at least the following steps:
a) adjusting the straightener system settings in order to straighten the pipe, and unwinding the pipe to launch into the sea a straight portion of pipe having a predetermined length LS greater than 300 m (300 meters);
b) adjusting the straightener system settings in order to under-straighten or over-straighten the pipe, and unwinding the pipe to launch into the sea a non-straight portion of pipe having a predetermined length (LE), said non-straight portion of pipe forming a Residual Curvature section (RC section) being used as an expansion loop to control the thermal expansion of the pipe;
wherein the non-straight portion of pipe produced during step b) comprises at least an under-straightened sub-portion of pipe and at least an over-straightened sub-portion of pipe, whereby the rotation of the non-straight portion of pipe in the catenary free span between the vessel and the sea bed is controlled so that the non-straight portion of pipe is installed horizontally on the seabed.

Optionally, the pipe comprises a plurality of non-straight portions of pipe. Optionally, each non-straight portion of pipe is co-planar. Optionally, each sub-portion of pipe in the non-straight portion of pipe is co-planar.

Optionally, the bending supports of the straightener system are comprised in a plane which is also the plane of the reverse curvature applied to the pipe. This plane is generally oriented vertically because in most laying vessels the reel axis is horizontal, hence the initial curvature of the pipe on the reel is comprised or almost comprised in a vertical plane.

Optionally, the reverse curvature and the initial curvature are in the same plane or almost in the same plane (preferably a vertical plane when the reel axis is horizontal) but the first in convex/curved inward (with reference to the reel axis), whereas the second is concave/curved outward.

According to a further aspect of the present invention there is provided a RC section comprising at least an under-straightened sub-section of pipe and at least an over-straightened sub-section of pipe. Advantageously, the “RC section plane” can rotate around the axis of the pipe when the RC feature is descending along the catenary and this rotation can be controlled so that the RC section plane is the same as the horizontal plane of the sea bed when the RC section is laid on the sea bed.

Optionally, the RC section comprises only one under-straightened sub-portion of pipe and only one over-straightened sub-portion of pipe.

Optionally, the RC section comprises only one under-straightened sub-portion of pipe and only two over-straightened sub-portions of pipe which are located on both sides on the under-straightened sub-portion of pipe. Advantageously, the over-straightened sub-portions of pipe act as wings, or counterweights, in the catenary sag bend and limit the overall rotation of the RC section to around 90°. When the axis of the reel on the vessel is horizontal and the stiffener system works in a vertical plane, a RC section rotation of around 90° ensures that the RC section is installed horizontally on the sea bed. As a consequence, the RC section can safely initiate a controlled buckling of the pipe in case of excessive axial compression due to thermal expansion. This second embodiment is of interest in deep water.

Optionally, the RC section comprises only one over-straightened sub-portion of pipe and only two under-straightened sub-portions of pipe which are located on both sides on the over-straightened sub-portion of pipe. This third embodiment is of interest in shallow water.

Optionally, the RC section comprises only two under-straightened sub-portions of pipe and only two over-straightened sub-portions of pipe.

Optionally, the RC section comprises at least one straight sub-portion of pipe located between at least one under-straightened sub-portion of pipe and at least one over-straightened sub-portion of pipe. Advantageously, this makes it possible to increase the length LE of the RC section, which can be useful to match the wavelength of natural buckles when such a wavelength is longer, such a matching ensuring a better control of the buckling.

Optionally, the RC section is arranged in a symmetric or antisymmetric way with reference to its center. Advantageously, such arrangements improve the control of the buckling.

Optionally, the local residual strain of each under-straightened sub-portion of RC section could be between 0.08% and 0.25%, more preferably between 0.1% and 0.2%. Furthermore, preferably, the local residual strain of each over-straightened sub-portion of pipe is between 0.02% and 0.1%, more preferably between 0.02% and 0.08%. Having the local residual strains in these ranges ensures that the mechanical properties of the pipe are not reduced by the straightener system. Over-straightening is more severe than under-straightening in terms of loads because of the higher reverse curvature to be applied by the straightener system, hence the local residual strains are preferably smaller for the over-straightened sub-sections than for the under-straightened sub-sections.

Optionally, each under straightened sub-portion of the RC section and/or each over straightened sub-portion of the RC section has a length between 15 m and 125 m. Furthermore, preferably, wherein each straight sub-portion of the RC section has a length between 15 m and 70 m.

Optionally, the vessel is stopped every time the settings of the straightener system are changed, for example during the steps a) and b). Advantageously, this ensures that the residual curvature of each sub-portion of the RC section is perfectly controlled, hence that the RC section as installed has the same shape and rotation behavior as the one modelled or tested during the design of the pipe. However, some movement of the vessel during a change of the configuration of the straightener system is also possible.

Optionally, the reel is stopped and does not rotate while the settings of the straightener system are changed, for example during the steps a) and b).

Advantageously, the pipe comprises more than one RC sections which improves the thermal expansion control.

Optionally, the method further comprises designing the characteristics of the RC section to control the rotation of the non-straight portion of pipe in the catenary free span between the vessel and the sea bed and ensure that the non-straight portion of pipe is installed horizontally on the seabed. Advantageously, this preliminary design and modelling of the pipe aims at determining the geometry and residual curvatures of the RC section, hence ensuring that when the RC section will be made during the pipe installation it will rotate as predicted and be installed horizontally on the sea bed.

According to a further aspect of the present invention there is provided a pipe whenever laid according to a method described herein.

According to another aspect of the present invention there is provided a method of forming a pipe having a non-straight portion of pipe comprising an under-straightened sub-portion of pipe and at least one over-straightened sub-portion of pipe comprising the steps of:
(a) providing a pipe from a reel on a vessel;
(b) passing the pipeline through a straightener system comprising bending supports for applying a curvature to the pipeline.

According to another aspect of the present invention is provided a pipe formed by the method as described herein.

According to another aspect of the present invention there is provided a pipe comprising an under-straightened portion of pipe and an over-straightened sub-portion of pipe.

Optionally, the pipe described herein has a non-regular portion of at least one under-straightened portion of pipe and at least one over-straightened sub-portion of pipe.

Optionally, the pipe described herein is consisting of or comprising only two under-straightened sub-portions of pipe and only two over-straightened sub-portions of pipe.

Optionally, the pipe described herein is consisting of or comprising only one over-straightened sub-portion of pipe.

Optionally, the pipe described herein is consisting of or comprising only two over-straightened sub-portions of pipe which are located on each side on the under-straightened sub-portion of pipe.

Optionally, the pipe described herein is consisting of or comprising only one over-straightened sub-portion of pipe and only two under-straightened sub-portions of pipe which are located on each side on the over-straightened sub-portion of pipe.

Optionally, the pipe described herein is consisting of or comprising only two under-straightened sub-portions of pipe and only two over-straightened sub-portions of pipe.

Optionally, the pipe described herein is comprising at least one straight sub-portion of pipe located between at least one under-straightened sub-portion of pipe and at least one over-straightened sub-portion of pipe.

Optionally, the pipe described herein is comprising a non-straight portion of pipe which comprises at least one under-straightened portion of pipe having a first local residual strain, and at least one over-straightened sub-portion of pipe having a second local residual strain which is different from the first local residual strain.

Optionally, the pipe described herein is comprising a non-straight portion of pipe which comprises an under-straightened portion of pipe having a first local residual strain, between two over-straightened sub-portions of pipe having a second local residual strain, the second local residual strain being smaller than the first local residual strain.

Optionally, the pipe described herein is comprising straight pipe portions between the under-straightened portion of pipe and two over-straightened sub-portions of pipe.

Optionally, the pipe described herein is comprising at least one under-straightened portion of pipe and at least one over-straightened sub-portion of pipe of different lengths.

Optionally, the pipe described herein is comprising at least one under-straightened portion of pipe and at least one over-straightened sub-portion of pipe, and at least one straight pipe thereinbetween.

According to a further aspect of the invention there is provided a pipe comprising: a straight portion, the straight portion having a predetermined length; and a non-straight portion, the non-straight portion having a predetermined length.

According to a further aspect of the invention there is provided a RC section comprising at least one under-straightened sub-portion of pipe and at least one over-straightened sub-portion of pipe.

According to a further aspect of the invention there is provided a vessel for forming and/or laying a pipe as described herein.

According to a further aspect of the invention there is provided a vessel for carrying out a method as described herein.

According to a further aspect of the invention there is provided a vessel comprising a pipe having an initial curvature, and a straightener system, wherein the straightener system is configured for: forming a straight portion of pipe, the straight portion having a predetermined length; and forming a non-straight portion of pipe, the non-straight portion having a predetermined length, wherein the non-straight portion comprises at least one under-straightened sub-portion of pipe and at least one over-straightened sub-portion of pipe.

### DESCRIPTION OF THE DRAWINGS

Other characteristics and advantages of the invention will become clear in the light of the following description, with reference to the attached drawings, in which:

FIG. 1 is side view of a vessel installing a pipe according to the prior art.

FIG. 2 is further side view of a vessel installing a pipe according to the prior art.

FIG. 3 shows schematic transverse views of four RC sections according to the prior art with four different angular positions.

FIG. 4 is a side view of a vessel installing a pipe according to an aspect of the present invention.

FIG. 5 is a schematic view of a method according to an aspect of the invention.

FIG. 6 is a schematic view of a RC section according to an aspect of the present invention.

FIG. 7 is a schematic view of a RC section according to an aspect of the present invention.

FIG. 8 is a schematic view of a further RC section according to an aspect of the present invention.

FIG. 9 is a schematic view of a further RC section according to an aspect of the present invention.

FIG. 10 is a schematic view of a further RC section according to an aspect of the present invention.

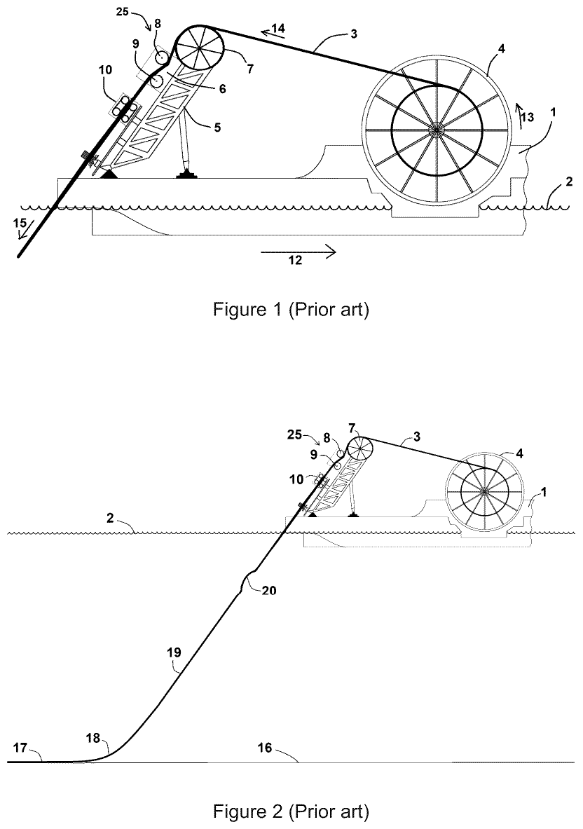

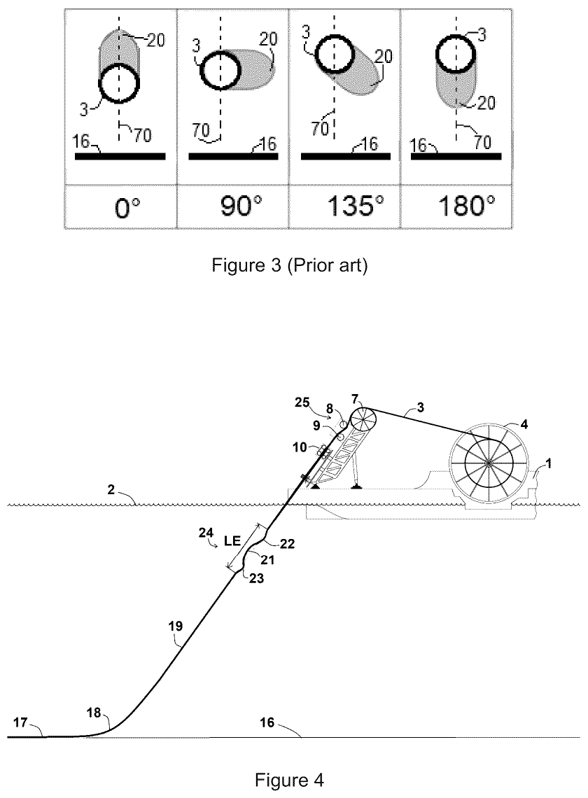

### DETAILED DESCRIPTION

FIG. 4 shows an apparatus in accordance with an aspect of the invention. The vessel 1 comprises a reel 4 wound with a plastically deformed rigid pipe 3. The pipe 3 has an initial curvature which depends on the radius of the reel 4. The vessel 1 also comprises a straightener system 25 through which the pipe 3 is fed before being installed on the sea bed 16. The vessel 1 comprises tensioning arrangement 10, such as caterpillars. The tensioning arrangement 10 is located downstream of the straightener system 25. The tensioning arrangement 10 is used to withstand the tension applied by the pipe 3 to the vessel 1 when the pipe 3 is installed subsea (the tension being mainly due to the weight of the pipe 3).

The straightener system 25 comprises bending supports 7, 8, 9 such as rollers or tracks for applying a reverse curvature to the pipe 3. The straightener system 25 has one or more adjustable settings in which the relative spacing or positioning of the bending supports 7, 8, 9 and/or the amount of pressure applied by the bending supports to the pipe 3 is adjusted. Movement of the relative positions of the bending supports achieves different configuration of the straightener system. In particular, an under-straightening configuration, an over-straightening configuration, and a straightening configuration.

The bending supports 7, 8, 9 are coplanar or almost coplanar and are arranged in a vertical plane perpendicular or almost perpendicular to the axis of the reel 4.

The vessel 1, reel 4, straightener system 25 and tensioning arrangement 10 are similar to those of the prior art, but they are configured and used in a different way. In particular, the straightener system 25 is configured for forming a straight portion of pipe 19 having a predetermined length LS and forming a non-straight portion of pipe 24 having a predetermined length LE, wherein the non-straight portion of pipe 24 comprises at least one under-straightened sub-portion of pipe 21 and at least one over-straightened sub-portion of pipe 22, 23.

At least three settings of the straightener system 25 are determined/calibrated before the offshore installation of the pipe 3. When the first setting is applied, the straightener system 25 perfectly straightens or almost perfectly straightens the pipe 3 and leaves it straight with no residual curvature. When the second setting is applied, the straightener system 25 under-straightens the pipe 3 and leaves it with a constant pre-determined residual curvature in the same direction as the initial curvature. When the third setting is applied, the straightener system 25 over-straightens the pipe 3 and leaves it with another constant pre-determined residual curvature in the opposite direction of the initial curvature. The first setting is applied to install straight portions of pipe 17, 19, and any intermediate straight sub-portions of pipe in a non-straight portion, whereas the second and third settings are respectively applied to make the under-straightened and over-straighten sub-portions of the RC section 24.

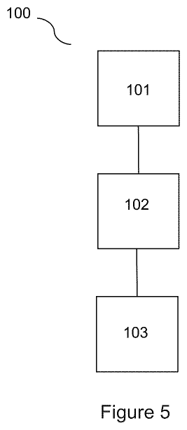

A method 100 according to an aspect of the invention is shown in FIG. 5. The method can be carried out using the vessel 1 shown in FIG. 4. The method 100 comprises: in step 101, providing a pipe 3 having an initial radius of curvature; in step 102, forming a straight portion of pipe 19, the straight portion of pipe 19 having a predetermined length LS; and, in step 103, forming a non-straight portion of pipe 24, the non-straight portion of pipe 24 having a predetermined length LE.

The method 100 is a method for laying a pipe 3 in a subsea location. During the laying operation, portions of the pipe 3 can be laid while other portions are being formed. For example, FIG. 4 shows a straight portion of pipe 19 and a non-straight portion of pipe 24 being laid while a further straight portion is being formed by the straightener system 25. During the laying operation the pipe 3 is continuously unwound from the reel 4.

In step 101 a pipe 3 having an initial radius of curvature is provided. The pipe 3 is provided on a reel 4 located on a vessel, for example vessel 1. Initially, the reel 4 is wound with the plastically deformed rigid pipe 3 such that the initial curvature of the pipe 3 is defined by the reel 4. The vessel 1 is guided to an offshore location where the pipe 3 is to be laid. An end of the pipe 3 is initially unwound from the reel and fed into the straightener system 25.

The straightener system 25 through which the pipe 3 is fed comprises bending supports 7,8,9 for applying a reverse curvature to the pipe 3. The relative spacing or positioning of the bending supports 7,8,9 and/or amount of pressure applied by the bending supports 7,8,9 to the pipe 3 is adjustable.

Before carrying out step 102, the straightener system 25 must be adjusted such that a length of pipe 3 passing through the straightener system 25 will be straightened and left with no residual curvature. The straightener system 25 is adjusted by altering the relative spacing or positioning of the bending supports 7,8,9.

In step 102 a straight portion of pipe 19 is formed. The straight portion of pipe 19 has a predetermined length LS. A length of pipe 3 is unwound from the reel 4 and passes through the straightener system 25 such that a length of the pipe 3 with no residual curvature is formed. After passing through the straightener system 25, the straight portion of pipe 19 can be laid. The straight portion of pipe 19 passes through the tensioning arrangement 10 and into the sea. The straight portion of pipe 19 falls toward the sea bed 16 on which the pipe 3 will rest, in use.

The vessel 1 moves in the direction that the pipe 3 is to be laid while the straight portion of pipe 19 is being formed and laid. Step 102 is carried out until a straight portion of pipe 19 of sufficient length has been formed. Once a straight portion of pipe 19 of sufficient length has been formed the vessel 1 stops (or at least slows), and the straightener system 25 is adjusted.

In step 103 RC section 24, which is a non-straight portion of pipe, is formed. The non-straight portion of pipe 24 has a predetermined length LE. A length of pipe 3 is unwound from the reel 4 and passes through the straightener system 25 such that a non-straight length of the pipe 3 having a desired length, curvature and profile is formed. The non-straight portion of pipe 24 is formed next to a straight portion of pipe 19. After passing through the straightener system 25 the RC section 24 of pipe 3 is laid. The RC section 24 passes through the tensioning arrangement 10 and into the sea. The non-straight portion of pipe 24 falls toward the sea bed 16 on which the non-straight portion of pipe 24 will rest, in use.

The vessel 1 moves in the direction that the pipe 3 is to be laid while the non-straight portion of pipe 24 is being formed and laid. Step 103 is carried out until a non-straight portion of pipe 24 of sufficient length and shape has been formed.

The straightener system 25 must be adjusted while carrying out step 103. As will be appreciated, during step 103 the straightener system 25 will need to be adjusted a number of times. The straightener system 25 is adjusted by altering the relative spacing or positioning of the bending supports 7,8,9.

The reel 4 can be stopped, i.e. stationary, every time the settings of the straightener system 25 are changed or adjusted. When it is stopped the reel 4 does not rotate and the pipe 3 cannot be unwound from the reel 4. As a consequence, the pipe 3 cannot move axially inside the straightener system 25 and there is no axial relative movement between the pipe 3 and the straightener system 25. This makes it possible to accurately control the position of the different points along the pipe where the straightener settings are changed. In addition, this ensures that the residual curvature of each sub-portion of the RC section 24 is perfectly controlled, hence that the RC section 24 as installed has the same shape and rotation behavior as the one modelled or tested during the design of the pipe.

The method of the present invention can also be provided without fully stopping the reel, provided that the amplitude of the axial movement of the pipe through the straightener system remains relatively low, typically less or equal than 6 meters, preferably between 1 meter and 6 meters, while the settings of the straightener system are changed or adjusted. According to this embodiment, the reel is not stopped and goes on rotating, preferably at reduced speed, while the settings of the straightener system are changed, which creates along the pipe a transition area which has a variable residual curvature, said transition area being located in between two adjacent portions or sub-portions of pipe which have both substantially constant residual curvatures. The length of the transition area is equal to the axial movement of the pipe at the straightener system while the settings of the straightener system are changed or adjusted. In other words, the length of the transition area is the length of pipe which passes through the straightener system while the settings of the straighter system are changed or adjusted. The length of the transition area is preferably comprised between 1 and 6 meters. The length of the transition area is preferably at least 30 times smaller than the predetermined length (LE) of the non-straight portion of pipe wherein the transition area is located. The maximum length of a transition area located in a 30 meters long RC section is preferably of around 1 meter. The maximum length of a transition area located in a 250 meters long RC section is preferably of around 6 meters. Reducing the length of the transition areas brings the advantage of better controlling the shape and the rotation behavior of the RC section. This can be provided by example by slowing down the reel rotation during the adjustment of the straightener settings and/or by reducing the time required to change the settings, for example by using more powerful and faster actuators to change the relative position of the bending supports of the straightener system, and/or having actuators controlled by a controller unit which is able to measure the pipe payout (i.e. spooling off) speed and position, and provide the required adjustments to the straightener system to still suit the expected modelling or design parameters. For example, the reel rotation is slowed down so that the pipe payout speed through the straightener is preferably of around 0.1 meters/second while the straightener settings are changed, which is 2 to 6 times smaller than the normal payout speed during installation. In addition, the time required to change the settings of the stiffener is preferably comprised between 10 seconds and 20 seconds, which leads to a transition area having a length comprised between 1 meter and 2 meters. The relative movement of the pipe in the straightener system can be factored into the required calculations or design parameters to still achieve the same shape and rotation behavior as the one modelled or tested during the design of the pipe.

The tensioning arrangement 10 is also preferably stopped when the settings of the straightener system 25 are changed or adjusted. When it is stopped the tensioning arrangement 10 keeps on maintaining the pipe tension (caterpillars tracks gripping the pipe and braking system activated), but it prevents the pipe 3 from moving axially with reference to the vessel 1. The reel 4 and the tensioning arrangement 10 being generally synchronized, it is safer and more practical to stop them together at the same time.

Preferably, the vessel 1 is also stopped every time the settings of the straightener system 25 are changed or adjusted Having the vessel 1 stationary while the reel 4 and tensioning arrangement 10 are stopped is a preferred solution because it is easy to implement, ensures a good control of the residual curvature applied to each sub-portion of the RC section 24, and also makes it easy to control the shape of the catenary riser.

However, the present invention could also be implemented without having the vessel 1 stationary while the settings of the straightener system 25 are changed or adjusted. For example if the horizontal movements of the vessel 1 are much smaller than the water depth, typically 20 times smaller, then the reel 4 and the tensioning arrangement 10 can be stopped while the vessel 1 is allowed to move within this limited range (typically within a 50 m horizontal range for a 1000 m water depth) and while the settings of the straightener system 25 are changed.

Stopping the reel 4 and the vessel 1 every time the straightener system settings are changed ensures that the residual curvature of each sub-portion of the RC section 24 is perfectly controlled, hence that the RC section 24 as installed has the same shape and rotation behavior as the one modelled or tested during the design of the pipe. In the present system, the RC section(s) 24 are created by periodically stopping the payout of the pipe from the vessel into the sea by stopping the reel, i.e. the reel is stationary, moving the straightener system 25, resuming payout of the pipe from the vessel by restarting unwinding of the reel for a desired pipe length, and repeating the procedure when next RC section 24 is to be laid. This method is more practical operationally than continuously moving the straightener system 25. Steps 102 and 103 are repeated until a suitable length of pipe 3, with a desired number of RC sections 24/straight portions 19, has been laid. When returning from step 103 to step 102 the straightener system 25 will need to be adjusted such that a length of pipe 3 passing through the straightener system 25 will be straightened and left with no residual curvature. The straightener system 25 is adjusted by altering the relative spacing or positioning of the bending supports 7,8,9. As will be appreciated, straight/non-straight portions can be formed by the straightener system 25 while previously-formed straight/non-straight portions are being laid from vessel 1.

Where the pipe 3 includes a plurality of non-straight portions, each non-straight portion of pipe is co-planar in the sense that it will be formed by the straightener system in the same plane. As will be appreciated, during the laying operation the plane of a RC portion 24 being formed by the straightener system 25 will be perpendicular to the plane of an RC portion 24 already formed, installed and lying horizontally on the sea bed 16.

The RC section 24 that is formed in step 103 comprises at least one under-straightened sub-portion of pipe 21 and at least one over-straightened sub-portion of pipe 22, 23. As shown in FIG. 4, the RC section 24 comprises at least an under-straightened sub-portion of pipe 21 and at least an over-straightened sub-portion of pipe 22, 23. The RC section 24 has a length LE which is between 30 m(30 meters) and 250 m(250 meters).

The under-and over-straightened sub-portions of pipe 21,22,23 of RC section 24 are curved in the same plane. The under-and over-straightened sub-portions of pipe 21,22,23 are comprised in the same plane because they are both made by the same straightener system 25. By adjusting the lengths, relative positions and residual curvatures of the under-straightened and over-straightened sub-portions of pipe 21,22,23 it is possible to design RC sections which will rotate by around 90° when they are installed, and therefore will be laid horizontally on the sea bed, including in deep water, which was not possible with the prior art methods.

Prior art RC sections were under-straightened all along their length with a constant residual curvature in the same direction as the initial curvature, because such RC sections were easy to make without imposing excessive loads on the straightener system. However, as it was not possible to control the rotation of such RC sections, they were often not installed horizontally on the sea bed, which reduced the ability of these RC sections to efficiently control the thermal expansion of the pipe. This drawback was particularly detrimental when the water depth is larger than around 1500 m which generally resulted in excessive rotations of the RC sections which then landed on the seabed with detrimental orientations, including facing downwards into the seabed.

The under-straightened and over-straightened portions of pipe have very different rotation behaviors to those of the prior art. Adding at least one over-straightened sub-portion of pipe to RC section 24 which comprises an under-straightened sub-portion of pipe significantly reduces the global rotation of the RC section 24, hence making it possible to install horizontally the RC section 24 on the sea bed in deep water. This technical effect can be obtained when the length LE of the RC section is comprised between 30 m and 250 m because the over and under-straightened sub-portions of pipe need to be close to each other to properly interact and counterweigh rotation. Both under and over-straightened sub-portions of pipe have residual curvatures of opposite signs and are comprised in the same plane because they are both made by the same straightener system 25.

Local residual strain ε is expressed in % and given by the formula ε=r×C×100, r being the outer radius in meters of the steel part of the pipe 3 (measured under the polymer external coating if any), and C being the local residual curvature of the pipe measured in m⁻¹. For example, if r=0.1 meter and C= 1/100 m⁻¹, then ε=0.1%

The local residual curvature C of RC section 24 is determined experimentally before the offshore installation of the pipe, by cutting a pipe sample which is reeled and straightened on the vessel 1 in the same conditions as those that will be used offshore when the RC section is made, then by measuring the residual bending radius R (in meters, absolute value, no sign) of this pipe sample (average bending radius of the pipe axis), and then by applying the formula C=1/R.

This measurement method is accurate when applied to a portion of pipe which has a residual bending radius being almost constant all along its length, which is the case when the settings of the straightener system are maintained constant while the portion of pipe is reeled and straightened. This method is therefore applicable to each under-straightened or over-straightened sub-portion of pipe of a RC section, which makes it possible to determine the local residual curvature and the local residual strain of each sub-portion of pipe.

This measurement method can also determine if a portion of pipe is under-straightened, straight or over straightened. If the residual bending radius R is larger than 500 meters, then the portion is straight. If R is smaller than or equal to 500 meters, then the orientation of the residual curvature compared to the initial curvature (pipe curvature on reel before straightening) determines whether the pipe portion is under-straightened (convex/curved inward with reference to the reel axis) or over-straightened (concave/curved outward with reference to the reel axis).

The local residual strain of each under-straightened sub-portion of RC section 24 could be comprised between 0.08% and 0.25%, more preferably comprised between 0.1% and 0.2%. Furthermore, preferably, the local residual strain of each over-straightened sub-portion of pipe is comprised between 0.02% and 0.1%, more preferably comprised between 0.02% and 0.08%. Having the local residual strains in these ranges ensures that the mechanical properties of the pipe are not compromised or reduced by the straightener system. Over-straightening is more severe than under-straightening in terms of loads because of the higher reverse curvature to be applied by the straightener system, hence the local residual strains are preferably smaller for the over-straightened sub-sections than for the under-straightened sub-sections.

The present invention provides suitable designs of the RC feature so that it rotates in a controlled manner in the catenary and lands horizontally on the seabed. This is achieved by designing and creating an RC feature consisting in multiple consecutive sub-sections or sub-portions, each with a constant residual curvature because the settings of the straightener system are maintained constant while each sub-portion is reeled and straightened. Each sub-portion of the RC feature has a constant plastic curvature, which can be negative, positive, or zero (straight pipe). The entire feature (comprised of one or multiple sections) will rotate all together achieving the same magnitude of rotation in the sag bend due to its relatively short length (typically 30 m to 250 m) when compared to the pipeline total length and catenary.

The main design principles to control the RC rotation are as follows. An under-straightened pipe section has a curvature in the opposite direction to the sag bend curvature. It has an unstable equilibrium in the sag bend, and the pipe will tend to rotate to minimize the bending and potential energy in the pipe section, therefore reaching a stable equilibrium. An over-straightened pipe section has a curvature in the same direction to the sag bend curvature. It is stable in the sag bend. Any rotation requires work to be done to increase the bending and potential energy in the pipe section. With a feature made of opposing curvatures in the RC feature, rotation of the pipe reduces the energy in the under-straightened section and increases the energy in the over-straightened section. By careful design of the geometry, and matching the under-straightened and over-straightened sections against each other, it is possible to find a configuration where the total energy in the sag bend is a minimum when the feature is in the horizontal plane.

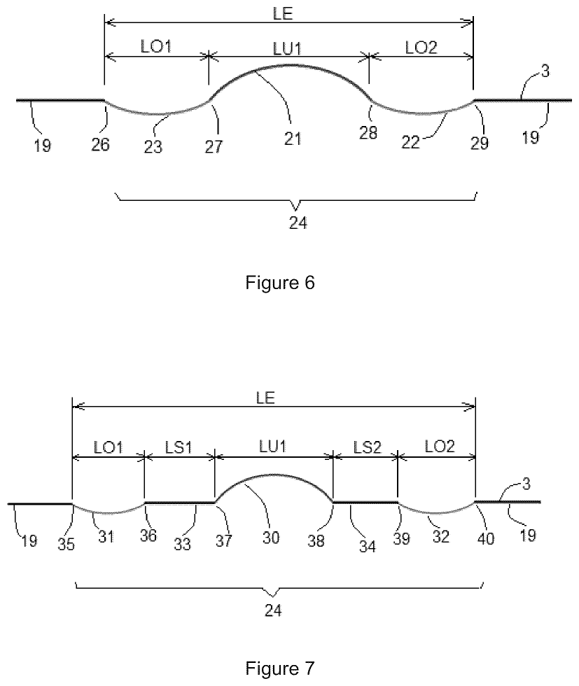

FIGS. 6 to 10 show a number of preferred geometries of the RC section 24.

In the preferred geometry of FIG. 6, the RC section 24 comprises only one under-straightened sub-portion of pipe 21 and only two over-straightened sub-portions of pipe 22, 23. The over-straightened sub-portions of pipe 22, 23 are located on either side of the under-straightened sub-portion of pipe 21. The over-straightened sub-portions of pipe 22, 23 and under-straightened sub-portion of pipe 21 are co-planar. The vessel 1 and/or reel 4 are stopped four times at points 26, 27, 28, 29 when making the RC section 24 shown in FIG. 6 i.e. at the points where the straightener system 25 is adjusted to each required configuration as part of step (b) of the method of the present invention, prior to returning to the configuration required for step (a).

In the preferred geometry of FIG. 7, the RC section 24 comprises only one under-straightened sub-portion of pipe 30 and only two over-straightened sub-portions of pipe 31, 32 which are located on either side of the under-straightened sub-portion of pipe 30. The RC section 24 furthermore comprises two straight sub-portions of pipe 33, 34 which are symmetrically arranged on both sides between the central under-straightened sub-portion of pipe 30 and both lateral over-straightened sub-portions of pipe 31, 32. The under-straightened sub-portion of pipe 30 and over-straightened sub-portions of pipe 31, 32 are co-planar. The vessel 1 and/or reel 4 are stopped six times at points 35, 36, 37, 38, 39, 40 when making the RC section 24 shown in FIG. 7 i.e. at the points where the straightener system 25 is adjusted to each required configuration as part of step (b) of the method of the present invention, prior to returning to the configuration required for step (a).

The example geometries of FIGS. 6 and 7 are designed to trigger a mode 3 lateral buckling. The main RC section (the under-straightened sub-portions of pipe 21, 30) will trigger the twist rotation in the catenary sag bend and overcome the additional torsional resistance due to the shoulder sections (over-straightened sub-portions of pipe 22, 23, 31, 32). The RC section rotation in the sag bend is required in order to ensure the RC section integrity in the sag bend. The shoulder sections will act as wings, or counterweights, in the catenary sag bend and limit the RC section overall rotation to around 90 degrees. A rotation of around 90 degrees is required to ensure that the RC section will be horizontal on the seabed and that the lateral offset will be maximum.

The main RC section (under-straightened) strains (0.1% to 0.2%) are higher than the shoulder sections (over-straightened) strains (0.02% to 0.08%). If the shoulder sections residual strains are too high, then the torsional resistance can be too high and the RC section overall rotation in the sag bend can be insufficient (e.g. 0 or 30 degrees), which will be detrimental to the RC section integrity in the sag bend and as-landed configuration. The over-straightened section strain magnitude is limited by the vessel equipment.

If the shoulder sections are too long with respect to the main crown length, then the torsional resistance can be too high and the RC section overall rotation in the sag bend can be insufficient (e.g. 0 or 30 degrees), which will be detrimental to the RC section integrity in the sag bend and as-landed configuration. The overall RC feature length should match the buckle wavelength for optimum in-place behavior. The design in FIG. 6 will be useful in the case of a shorter buckle wavelength (up to 150 m), while the design in FIG. 7 will be useful in the case of a longer buckle wavelength (above 150 m).

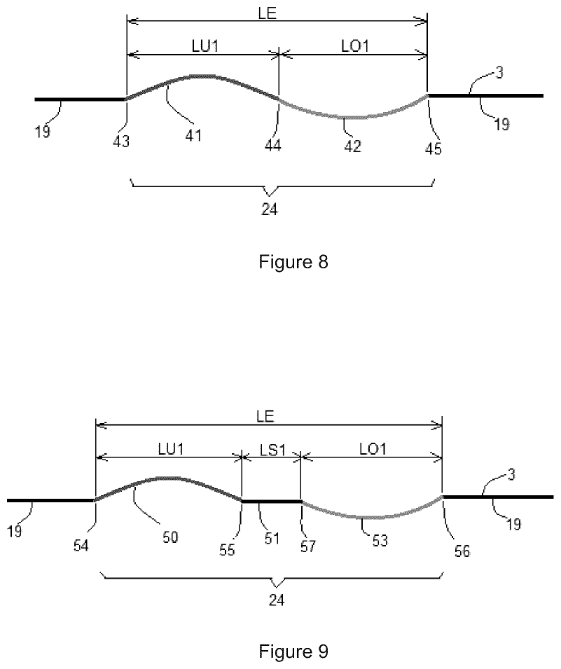

In the preferred geometry of FIG. 8, the RC section 24 consists of one under-straightened sub-portion of pipe 41 and one over-straightened sub-portion of pipe 42. The under-straightened sub-portion of pipe 41 and one over-straightened sub-portion of pipe 42 are co-planar. The vessel 1 and/or reel 4 are stopped three times at points 43, 44, 45 when making the RC section 24 shown in FIG. 8 i.e. at the points where the straightener system 25 is adjusted to each required configuration as part of step (b) of the method of the present invention, prior to returning to the configuration required for step (a).

In the preferred geometry of FIG. 9, the RC section 24 consists of one under-straightened sub-portion of pipe 50 and one over-straightened sub-portion of pipe 53 both separated by a straight sub-portion of pipe 51. The under-straightened sub-portion of pipe 50 and over-straightened sub-portion of pipe 53 are co-planar. The vessel 1 and/or reel are stopped four times at points 54, 55, 57, 56 when making the RC section shown in FIG. 9 i.e. at the points where the straightener system 25 is adjusted to each required configuration as part of step (b) of the method of the present invention, prior to returning to the configuration required for step (a).

The example geometries of FIGS. 8 and 9 are designed to trigger a mode 2 lateral buckling. The under-straightened RC section (the under-straightened sub-portions of pipe 41,50) will trigger the twist rotation in the catenary sag bend and overcome the additional torsional resistance due to the over-straightened section. The RC section rotation in the sag bend is required in order to ensure the RC section integrity in the sag bend. The over-straightened section (over-straightened sub-portions of pipe 42, 53) will act as a wing, or counterweight, in the catenary sag bend and limit the RC feature overall rotation to around 90 degrees. A rotation of around 90 degrees is required to ensure that the RC section will be horizontal on the seabed and that the lateral offset will be maximum. The two RC sub-sections have a residual curvature of opposite sign. Their strain magnitude and length will be different in order to achieve a 90 degree rotation in the sag bend. The under-straightened section will have higher strain magnitude or length in order to trigger the rotation in the sag bend. If the over-straightened section residual strain magnitude is too high, then the torsional resistance can be too high and the RC section overall rotation in the sag bend can be insufficient (e.g. 0 or 30 degrees), which will be detrimental to the RC section integrity in the sag bend and as-landed configuration. If the over-straightened section is too long with respect to the main crown length, then the torsional resistance can be too high and the RC section overall rotation in the sag bend can be insufficient (e.g. 0 or 30 degrees), which will be detrimental to the RC section integrity in the sag bend and as-landed configuration. The overall RC feature length should match the buckle wavelength for optimum in-place behavior.

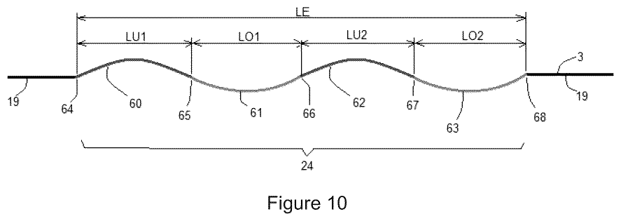

In the preferred geometry of FIG. 10, the RC section 24 consists of two under-straightened sub-portions of pipe 60, 62 and two over-straightened sub-portions of pipe 61, 63 which are arranged in an antisymmetric way with reference to the center of the RC section 26. The under-straightened sub-portions of pipe 60, 62 and over-straightened sub-portions of pipe 61, 63 are co-planar. The vessel 1 and/or reel 4 are stopped five times at points 64, 65, 66, 67, 68 when making the RC section shown in FIG. 10, i.e. at the points where the straightener system 25 is adjusted to each required configuration as part of step (b) of the method of the present invention, prior to returning to the configuration required for step (a).

The example geometry of FIG. 10 is designed to trigger a mode 4 lateral buckling. The under-straightened RC sections (the under-straightened sub-portions of pipe 60,62) will trigger the twist rotation in the catenary sag bend and overcome the additional torsional resistance due to the over-straightened sections (over-straightened sub-portions of pipe 61, 63). The RC section rotation in the sag bend is required in order to ensure the RC integrity in the sag bend. The over-straightened sections will act as wings, or counterweights, in the catenary sag bend and limit the RC feature overall rotation to around 90 degrees. A rotation of around 90 degrees is required to ensure that the RC section will be horizontal on the seabed and that the lateral offset will be maximum. Each section strain magnitude and length can be different to achieve a 90 degree rotation in the sag bend. At least one of the under-straightened sections will have higher strain magnitude or length in order to trigger the rotation in the sag bend. If the over-straightened sections residual strains are too high, then the torsional resistance can be too high and the RC section overall rotation in the sag bend can be insufficient (e.g. 0 or 30 degrees), which will be detrimental to the RC section integrity in the sag bend and as-landed configuration. If the over-straightened sections are too long with respect to the main crown length, then the torsional resistance can be too high and the RC section overall rotation in the sag bend can be insufficient (e.g. 0 or 30 degrees), which will be detrimental to the RC section integrity in the sag bend and as-landed configuration. The overall RC feature length should match the buckle wavelength for optimum in-place behavior.

With reference to FIGS. 6 to 10, each under-straightened sub-portion of pipe 21, 30, 41, 50, 60, 62, has a length LU1, LU2 preferably between 15 m (15 meters) and 125 m (125 meters). Each over-straightened sub-portion of pipe 22, 23, 31, 32, 42, 53, 61, 63 has a length LO1, LO2 preferably between 15 m (15 meters) and 125 m (125 meters). Each straight sub-portion of pipe 33, 34, 51 has a length LS1, LS2 preferably comprised between 15 m (15 meters) and 70 m (70 meters).

An advantage of the invention is that it ensures that RC features are installed horizontally on the seabed, thus avoiding the complications linked to an RC feature landing with excessive rotation or inverted configuration (reduced lateral offset, more critical lateral buckling triggering and post-buckle behavior).

A further advantage of the invention is that it allows for flexibility in the design by varying each section length and/or curvature to achieve 90 degree rotation. This can be used to vary the design depending on: the RC section location with respect to other RC sections, which will influence the RC section rotation; seabed features, such as curved sections, which have an effect on the RC section rotation, or bathymetry/slopes; structures/PLET, and in particular the distance to these structures which influences the RC section rotation. The design flexibility of the proposed invention can also address the challenge of having multiple RC sections in the catenary, where the rotation magnitude of an RC section can influence the rotation of other RC sections in the catenary.

Further advantage of the invention is that, while allowing for rotation control in the sag bend, it improves significantly the global buckling behavior on the seabed: (i) by ensuring the RC feature lands horizontally on the seabed, therefore avoiding critical orientation (inverted, reduced lateral deflection); (ii) by allowing to reduce the buckling initiation force and the post-buckle loads and strains by distributing the buckle into the multiple sections; (iii) by designing the RC feature shape according to the buckling mode and wavelength of the pipe on the seabed (which will depend on many parameters including pipeline and pipe-soil interaction parameters); and (iv) by modifying the buckle wavelength using the RC feature design in order to improve the global buckling behavior.

In the present application, the terms “non-straight portion of pipe”, “Residual Curvature section”, “RC section” and “RC feature” have the same meaning and cover the same feature.

The term “pipe” as used herein includes a pipeline, and can be formed in a manner able to be reeled on a reel of a sea laying vessel.

In the present application, a straight portion of pipe is a portion of pipe which has a radius of curvature larger than 500 m (absolute value, no sign). Another equivalent definition is that the curvature of a straight portion of pipe (absolute value, no sign) is smaller than 1/500 m⁻¹

The straightener system 25 is preferably adjusted by a control system of the vessel 1, for example a control computer and one or more actuators. The straightener system 25 is adjusted, for example by the aforementioned control system, while the reel 4 is stopped and/or the vessel 1 is stationary.

In optional embodiments rotation of the RC feature(s) can also be controlled by monitoring the pipeline rotation in the catenary during pipe lay and adjusting the rotation by controlling the vessel position. This can be achieved using any monitoring method, including gyroscopic sensors clamped to the pipeline, or visual method using ROV and markings on the RC feature. Furthermore, rotation of the RC feature(s) can also be controlled by physical equipment on the pipeline (buoyancy, ballast) to increase or reduce the rotation of the RC feature.

1. A method for laying a pipe on a seabed from a vessel, said vessel comprising a reel wound with deformable rigid pipe having an initial curvature and a straightener system through which the pipe is provided, the method comprising at least the following steps:
a) configuring the straightener system to straighten a pipe, and unwinding the pipe from the reel to provide a straight portion of pipe having a predetermined length (LS) greater than 300 m;
b) configuring the straightener system to provide a non-straight portion of pipe having a predetermined length (LE);
wherein the non-straight portion of pipe produced during step b) comprises at least one under-straightened sub-portion of pipe and at least one over-straightened sub-portion of pipe.

2. The method according to claim 1, wherein the straightener system comprises bending supports for applying a curvature to the pipe.

3. The method according to claim 2, wherein said straightener system comprises bending supports for applying a reverse curvature to a pipe, and having one or more adjustable settings selected from relative spacing or positioning of the bending supports and/or amount of pressure applied by the bending supports to the pipe, said straightener system being adapted to straighten the pipe and leave the pipe with no residual curvature, and/or to under-straighten the pipe and leave the pipe with a residual curvature in the same direction as the initial curvature, and/or to over-straighten the pipe and leave the pipe with a residual curvature in the opposite direction as the initial curvature.

4. The method according to claim 1, wherein step (b) comprises configuring the straightener system to two or more of the group comprising: to under-straighten a sub-portion of the pipe, to over-straighten a sub-portion of the pipe, and to straighten a sub-portion of the pipe; followed after each configuration by unwinding the sub-portion of the pipe from the reel.

5. The method according to claim 1, wherein the non-straight portion of pipe consists of or comprises only one under-straightened sub-portion of pipe and at least one over-straightened sub-portion of pipe.

6. The method according to claim 1, wherein the non-straight portion of pipe consists of or comprises at least one under-straightened sub-portion of pipe and only one over-straightened sub-portion of pipe.

7. The method according to claim 1, wherein the non-straight portion of pipe consists of or comprises only two over-straightened sub-portions of pipe which are located on each side of the under-straightened sub-portion of pipe.

8. The method according to claim 1, wherein the non-straight portion of pipe consists of or comprises only one over-straightened sub-portion of pipe and only two under-straightened sub-portions of pipe which are located on each side of the over-straightened sub-portion of pipe.

9. The method according to claim 1, wherein the non-straight portion of pipe consists of or comprises only two under-straightened sub-portions of pipe and only two over-straightened sub-portions of pipe.

10. The method according to claim 1, wherein the non-straight portion of pipe comprises at least one straight sub-portion of pipe located between at least one under-straightened sub-portion of pipe and at least one over-straightened sub-portion of pipe.

11. The method according to claim 1, wherein the non-straight portion of pipe is arranged in a symmetric or asymmetric way with reference to the center of the non-straight portion of pipe.

12. The method according to claim 1, wherein the local residual strain of the or each under-straightened sub-portion of pipe is between 0.08% and 0.25%.

13. The method according to claim 1, wherein the local residual strain of the or each over-straightened sub-portion of pipe is between 0.02% and 0.1%.

14. The method according to claim 1, wherein the or each under straightened sub-portion of pipe has a length between 15 m and 125 m.

15. The method according to claim 1, wherein the or each over straightened sub-portion of pipe has a length between 15 m and 125 m.

16. The method according to claim 10, wherein the or each straight sub-portion of pipe has a length between 15 m and 70 m.

17. The method according to claim 1, wherein the method comprises adjusting the settings of the straightener system to provide a different configuration of the straightener system in step (a) or step (b), and wherein the vessel is stationary when the settings of the straightener system are adjusted.

18. The method according to claim 1, wherein the method comprises adjusting the settings of the straightener system to provide a different configuration of the straightener system in step (a) or step (b), and wherein the reel is stopped or stationary when the settings of the straightener system are adjusted.

19. The method according to claim 1, further comprising:
c) repeating steps a) and b) until the deformable rigid pipe is fully installed on a seabed.

20. The method according to claim 1, further comprising:
b0) designing the characteristics of the non-straight portion of pipe to control the rotation of the non-straight portion of pipe in the catenary free span between the vessel and the sea bed and ensure that the non-straight portion of pipe is installed horizontally on the seabed.

21. The method according to claim 1, wherein the non-straight portion of pipe has a predetermined length (LE) between 30 m and 250 m.

22. A pipe laid according to the method of claim 1, having a non-straight portion of pipe comprising at least one under-straightened sub-portion of pipe and at least one over-straightened sub-portion of pipe.

23. A pipe formed by the method of claim 1, having a non-straight portion of pipe comprising at least one under-straightened sub-portion of pipe and at least one over-straightened sub-portion of pipe.

24. A pipe as claimed in claim 22, wherein the non-straight portion of pipe has only one over-straightened sub-portion of pipe and only one under-straightened sub-portion of pipe.

25. A pipe as claimed in claim 22, wherein the non-straight portion of pipe has only one under-straightened sub-portion of pipe and only two over-straightened sub-portions of pipe which are located on each side on the under-straightened sub-portion of pipe.

26. A pipe as claimed in claim 22, wherein the non-straight portion of pipe has only one over-straightened sub-portion of pipe and only two under-straightened sub-portions of pipe which are located on each side on the over-straightened sub-portion of pipe.

27. A pipe as claimed in claim 22, wherein the non-straight portion of pipe has only two under-straightened sub-portions of pipe and only two over-straightened sub-portions of pipe.

28. A pipe as claimed in claim 22, wherein the non-straight portion of pipe comprises at least one straight sub-portion of pipe located between at least one under-straightened sub-portion of pipe and at least one over-straightened sub-portion of pipe.

29. A pipe as claimed in claim 22, wherein the non-straight portion of pipe comprises at least one under-straightened sub-portion of pipe (21) having a first local residual strain, and at least one over-straightened sub-portion of pipe (22) having a second local residual strain which is different from the first local residual strain.

30. A pipe as claimed in claim 29, wherein the non-straight portion of pipe comprises an under-straightened sub-portion of pipe having a first local residual strain between two over-straightened sub-portions of pipe having a second local residual strain, the second local residual strain being smaller than the first local residual strain.

31. A pipe as claimed in claim 25, wherein the non-straight portion of pipe comprises straight sub-portions of pipe between the under-straightened sub-portion of pipe and two over-straightened sub-portions of pipe.

32. A pipe as claimed in claim 22, wherein the non-straight portion of pipe comprises at least one under-straightened portion of pipe and at least one over-straightened sub-portion of pipe of different lengths.

33. A pipe as claimed in claim 22, wherein the non-straight portion of pipe comprises at least one under-straightened portion of pipe and at least one over-straightened sub-portion of pipe, and at least one straight portion of pipe thereinbetween.

34. A vessel for carrying out the method according to claim 1.

35. A vessel for forming and/or laying a pipe according to claim 22.
